(19) United States
(12) Patent Application Publication
(10) Pub. No.: US 2002/0061062 A1
(43) Pub. Date: May 23, 2002

(54) Filtering system and method for digital interactive streams

(76) Inventor: Royal O'Brien, Jacksonville, FL (US)

Correspondence Address: Mark J. Young, McGuireWoods LLP, Suite 3300, 50 N. Laura Street, Jacksonville, FL, 32202-3661, US

(21) Appl. No.: 09/800,146

(22) Filed: Mar. 6, 2001

Related U.S. Application Data
(60) Provisional application No. 60/252,788, filed on Nov. 22, 2000.

(51) Int. Cl. H04N 11/04; H04N 11/02; H04N 7/12; H04B 1/66

(52) U.S. Cl. 375/240.01

(57) ABSTRACT

A system and methodology for eliminating noise distortions and mosaic effects from decoded multimedia data. Such system and methodology preferably uses an encoding/decoding application such as that developed by the Moving Picture Experts Group (MPEG). The present invention ideally processes selected sections of sub-macroblocks of pixels based on a constant established threshold derived from human perception of gradients in color hues. By applying unique algorithms for sub-macroblock edge correction, noise correction, and temporal correction, the present invention enables a method for eliminating decompressed video image distortions.

### RELATED APPLICATION

This application claims the benefit of U.S. Provisional Application No. 60/252,788, filed Nov. 22, 2000, entitled DIGITAL INTERACTIVE STREAMS SYSTEM AND METHOD, which is hereby incorporated by reference for all purposes.

### BACKGROUND OF THE INVENTION

1. Field of the Invention

The present invention relates generally to a process for filtering digital interactive streams in a broadcast networking medium, and in particular, to a system and method for filtering decompressed digital interactive streams in real time to provide clarity of resolution and display.

2. Background of the Prior Art

Rapid developments in digital technology have produced a new feature in multimedia entertainment, that being the convergence of the Internet and television to create interactive television. Unfortunately, present broadcast network structures are unable to effectively deliver interactive television because they have not kept apace with technology's expansion. In particular, copper telephone wire, which connects most residential consumers to a broadcast network, is often inefficient in delivering the large amounts of information required for interactive television entertainment. With twisted copper pairs, substantial blocks of information progress slowly and will often bottleneck during delivery. An attempt by the broadcast industry to address the issue of delayed data delivery to consumers requires expensive deployment of fiber optic cable closer in proximity to the consumer.

To ensure consistent global outreach of new technology given the present broadcast network structure, the Motion Picture Experts Group (MPEG) devised a process for delivering universal information using less bandwidth while being able to transfer more information. Specifically, MPEG established various video compression standards or processes, including MPEG-1, MPEG-2, MPEG-3, and MPEG-4. Such conventional video compression techniques utilize similarities between successive image frames, referred to as temporal or inter-frame correlation, to provide inter-frame compression in which pixel-based representations of image frames are converted to motion representations. Moreover, similarities within image frames, referred to as spatial or intra-frame correlation, are used to provide intra-frame compression in which the motion representations within an image frame are further compressed.

The latest version of compression techniques, MPEG-4, enables highly efficient compressed transmission of multimedia entertainment information to enable faster speed delivery to an end user's networking medium. Unfortunately, a current problem with applying MPEG-4 technology in today's television displays is that upon data decompression at the networking medium, the resulting image display after decompression is often riddled with a “mosaic” effect, noise distortions, and unclear resolution due to video image size constraints.

A current solution for eliminating the “mosaic” effect and noise distortions while increasing resolution is to increase the amount of information transferred to an end user. Today's broadcast communication networks are unable to transmit on a broadband greater than 1.5-megabit. Unfortunately, transmission of a “clearer” video image to a user requires a broadcast transmission bandwidth greater than the 1.5-megabit limitation imposed by current broadcast network structures.

Conventional solutions to improve images translated in MPEG-2 require amending pixel luminance signals based on the rate of information compression or gradient block pixel contrast. Such solutions do not address basing filtration application on human perception. Another solution to correct distortions in MPEG translated images suggests a method for filtering video image distortions during the encoding and compression process. This solution, however, does not account for inherent distortions produced during image decompression.

### SUMMARY OF THE INVENTION

The present invention overcomes the limitations identified above as well as limitations in other prior systems. An object of the present invention is to provide a system and method of filtering decompressed information to enable more natural looking displays for end user entertainment. In particular, the present invention preferably prevents a plurality of distracting effects generated by the decompression process, such as the mosaic effect and noise distortions.

Another object of the present invention is to ensure only necessary changes are made to an image while leaving correct information untouched. This allows the filter to only work as hard as is required. As such, the better the encoded content, the less work the filter performs. A related object is to provide filtered information in an efficient and timely fashion.

Yet another object of the present invention is the ability to apply the system and method for filtering to substantially all digital streams. Specifically, the system and method for filtering may be applicable to all compressed/encoded streams, including MPEG-1, MPEG-2 and MPEG-4 streams.

The present invention accordingly enables a method and system for filtering a plurality of digital interactive streams providing multimedia entertainment information. The purpose of the filter is to provide increased resolution and clarity of multimedia representation for user entertainment. In an embodiment of the present invention, a method for filtering includes identifying distorted pixels and adjusting the luminance signal supplied by a distorted pixel to suppress video image distortions.

Current compression techniques transform video representation data into coded blocks of pixel information. A filter, according to the present invention, preferably compares the difference in hue between selected pixels along the edge of the blocks against corresponding pixels of an adjacent block. The absolute value of the difference is evaluated against an established threshold to determine whether to perform correction. Should correction be required, the filter calculates weighted hue values for both the selected pixel and the compared pixel to be inserted into the sub-macroblock before presentation. As such, the filter preferably reduces the “mosaic” effect and removes noise artifacts.

A filtering method, according to the present invention, preferably includes the steps of calculating the difference in R, G, B vector values for a given pair of adjacent pixels and comparing the vector against a pre-determined threshold figure to provide an indicator for the given pixels. Should the vector fall outside the threshold figure, the method ideally initiates hue correction for the given pair of pixels. To correct pixel hue, the filter preferably calculates weighted hue values for both the selected pixel and the compared pixel to be inserted into the video image before presentation. Accordingly, the filtering result corrects erratic pixel luminance generated during data encoding and decompression to effectively suppress mosaic distortion and remove noise artifacts.

### BRIEF DESCRIPTION OF THE DRAWINGS

These and other features, aspects, and advantages of the present invention will become better understood upon review of the following description of an embodiment thereof and shown in the accompanying drawings, in which:

FIG. 1 illustrates a high level block of a system including an embodiment of the present invention;

FIG. 2 represents a sub-macroblock of 8×8 pixels consistent with the present invention; and

FIGS. 3-6 are flowcharts illustrating steps involved in the filtering method according to the present invention.

### DETAILED DESCRIPTION

The invention summarized above and defined by the enumerated claims may be better understood by referring to the following detailed description, which should be read in conjunction with the accompanying drawings. The following detailed description enables one in creating and using a particular implementation of the invention and is not intended to limit the enumerated claims, but to serve as an example thereof. The present invention may be applied in connection with any MPEG decoder. In order to facilitate an understanding of the invention, some pertinent aspects of MPEG compression algorithm are first reviewed. Those skilled in the art should appreciate that they may apply the present invention to other coding algorithms sharing similar features of the MPEG algorithm.

As set forth by the International Organization for Standardization, ISO-IEC JTC1/SC29/WG11, July 2000, a multimedia entertainment representation is encoded (compressed) into a standard format for transmission. The present invention is preferably applied to video representation information. MPEG encoding compression transforms video representation data into coded blocks of information that are more efficiently transported over a network. Such blocks are preferably split into 8×8 pixels per sampling information site area, denoted in the present invention as a sub-macroblock. Information is compressed when only the difference in matching, or near matching, blocks are transmitted through a vector movement code. Typically, a frame size used for video is that of 512×384 pixels. Through use of this type of compression technique, multimedia information transmission is enhanced while utilizing significantly less bandwidth.

In general terms, a filter method of the present invention operates on multimedia data that has been encoded, transmitted, and finally decoded to yield sub-macroblocks of pixels. Typically, red (R), green (G), and blue (B) color signals describe a video image. A conventional color matrix circuit processes these signals to generate a luminance signal.

According to the present invention, in processing such sub-macroblocks of pixels, the filter preferably compares the difference in hue between selected pixels along the edge of the blocks against corresponding pixels of an adjacent sub-macroblock. The absolute value of the difference is evaluated against an established threshold to determine whether to perform correction. Should correction be required, the filter calculates weighted hue values for both the selected pixel and the compared pixel to be inserted into the sub-macroblock before presentation. As such, the filter preferably reduces the “mosaic” effect and removes noise artifacts.

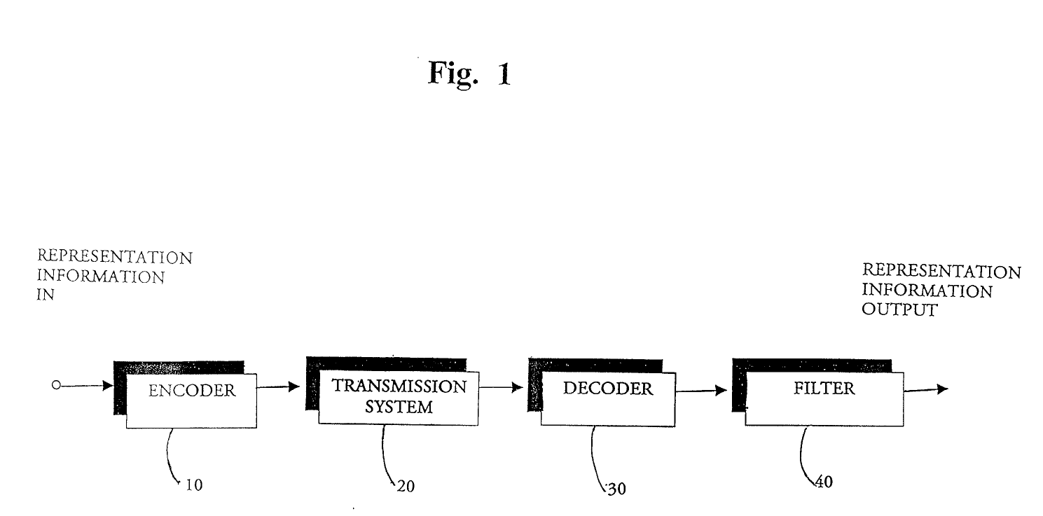

FIG. 1 illustrates a high-level block diagram of a system including an embodiment of the present invention. A filter consistent with the present invention preferably processes data that has been encoded, transmitted, and finally decoded to yield blocks of pixels. Specifically, filter 40 is ideally enabled in a digital delivery system to process video and audio data delivered via an encoder 10, a transmission system 20, and a decoder 30.

Encoder 10 codes multimedia data representation input signals. MPEG encoding algorithm is preferably applied by the encoder 10 to compress the multimedia data for transmission. Transmission system 20 preferably relays the compressed data to a networking medium for user entertainment. Transmission system 20 may include radio wave transmission, satellite broadcast, cable distribution, microwave transmission, and the like. When the compressed data is at a networking medium, decoder 30 translates the data into blocks of pixels for entertainment display.

Multimedia data translated by decoder 30 is preferably converted into a block of 640×480 pixels representing a video image frame. Such block is further divided into sub-macroblocks wherein sixty-four pixels are arranged in a matrix of eight horizontal pixels by eight vertical pixels. Ultimately prior to display, filter 40 receives the sub-macroblocks from decoder 30 and applies edge correction, noise correction, and temporal correction protocols to individual pixels within sub-macroblocks to suppress relay of poor entertainment display to a user.

A networking medium consistent with the present invention includes a video decoding system and a filtering system, which operates in real-time mode. In real-time operation, a video filtering system consistent with the present invention applies protocols for correcting sub-macroblock edges and maintaining frame resolution after video representation decompression. The filtering system includes PC hardware, preferably having a processing unit, to generate field statistics for identifying anomalous pixel bits requiring correction. Such field statistics ideally include software metrics designed to extract salient features from a large amount of pixel data. Once an anomalous pixel bit is identified, the filtering system directs the insertion of a correct pixel bit to be inserted into the frame and the removal of the anomalous pixel bit.

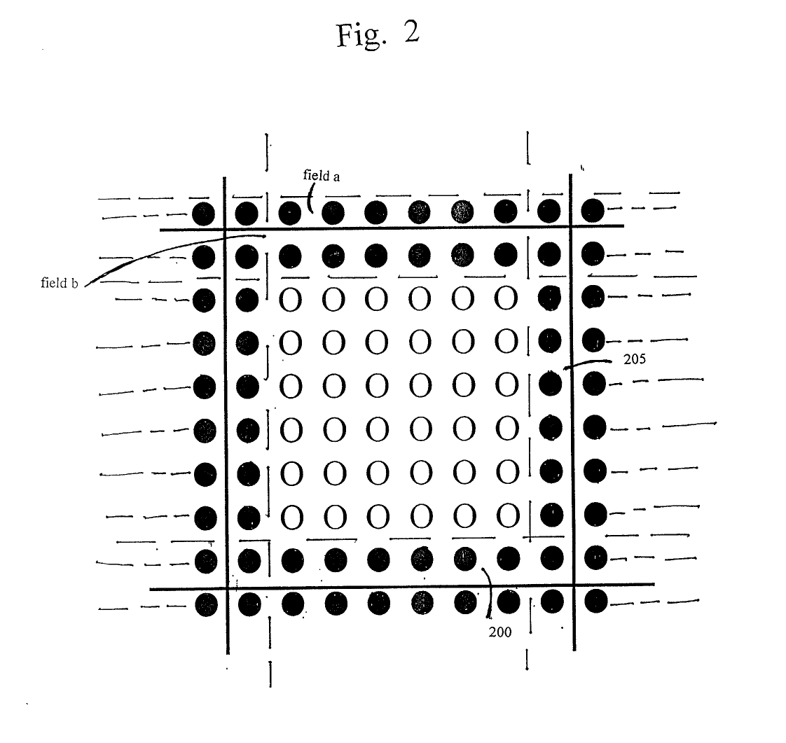

According to the present invention, the first step to filtering a decompressed video representation frame is to copy the original video frame to provide a source of reference during pixel correction. Once a copy is created, a sub-macroblock “edge” is identified for filter processing. As illustrated in FIG. 2, an “edge” preferably includes either a bottom horizontal row, in area 200, of 8 pixels on the border of a sub-macroblock or a right vertical column, in area 205, of 8 pixels on the border of a sub-macroblock. While an “edge” is depicted as either a bottom horizontal row or right vertical column, it is generally applicable to any linearly aligned consecutive pixels within a sub-macroblock.

Fields a and b preferably denote horizontal rows or vertical columns of adjacent sub-macroblock edges. Ideally, each nth pixel in an “edge” is denoted in either field a or b, and individually includes R, G, B values to create a plurality of colors. R, G, B values respectively represent red, green, and blue phosphor colors having varying phosphorous luminance intensities.

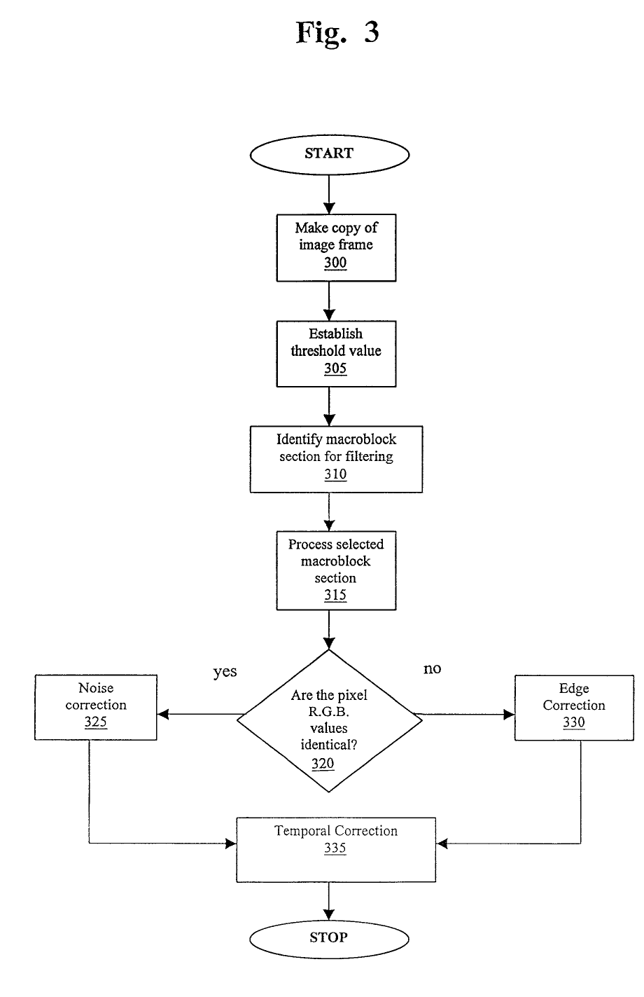

According to FIG. 3, a first step 300 in the filtering methodology is to generate a copy of the video image frame for reference. Once a copy of the image is created, a threshold value is established in step 305. Ideally, the threshold value is determined as a measure of human perception of various shades of color. In general, a human being is capable of perceiving 13 gradients of shading in a single R, G, B color hue.

Once a threshold value is established 305, a section of a sub-macroblock of pixels is identified for filtering in step 310. In an embodiment of the present invention, pixels in an “edge” are selected for filtering. Once a section is identified and selected in step 310, every R, G, B value per selected pixel is processed by the filtering method in step 315. Should the R, G, B value for the processed pixels all be identical, the filtering process initiates noise correction in step 325. However, should th(R, G, B values for the processed pixels vary amongst selected pixels, the filtering system enables edge correction in step 330. At the completion of either edge correction in step 330 or noise correction in step 325, the pixels in the “edge” are preferably evaluated against corresponding pixels in the following video image frame to conduct temporal correction in step 335.

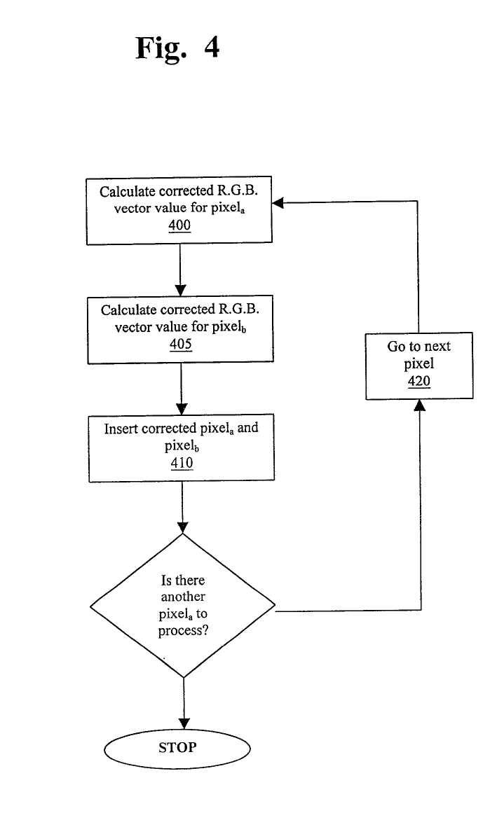

The process for filtering noise distortions is illustrated in FIG. 4. A preferable first step 400 includes applying statistical computations to the selected pixels to perform immediate noise correction. Such statistical computation is performed recursively until every pixel in an “edge” has been corrected.

With reference to FIG. 4, preferable recursive statistical computations to calculate corrected R, G, B vector values for a given pixel ‘n’ in a selected “edge” field a or “edge” field b include:

(1) the sum of the R, G, B vector values in the nth pixel in field a and double the R, G, B vector values in corresponding nth pixel in field b; and

(2) the multiplication of the calculated sums for each individual R, G, B vector value by one-third.

In FIG. 4, steps 400 through 420 represent ideal recursive statistical application steps for calculating an adjusted pixel to correct noise distortion. Step 400 directs calculating corrected individual R, G, B values for a given pixel in field a. Such calculation preferably entails taking the sum of individual R, G, B values for the nth pixel in field a plus double a corresponding nth pixel's R, G, B values in field b. Weighted corrected measures of individual R, G, B values are preferably determined by multiplying the calculated sum values for individual R, G, B by one-third (⅓). Such computation captures pixel R, G, B values in field b to be contributed to the correction of the given nth pixel in field a.

Further correction of noise distortion is enabled in step 405. Step 405 directs calculating corrected individual R, G, B values for a given corresponding pixel in field b. Such calculation preferably entails taking the sum of individual R, G, B values for an nth pixel in field b plus double a corresponding nth pixel's R, G, B values in field a. Such calculation preferably references an original image frame, as copied in step 300 (FIG. 3), to ensure accurate noise correction. The weighted corrected measures of individual R, G, B values for a pixel in field b are preferably determined by multiplying the calculated sum values for individual R, G, B by one-third (⅓). Such computation captures R, G, B values for the nth pixel in field a to be contributed to the correction of the given nth pixel in field b.

In step 410, the resulting weighted corrected measures of individual R, G, B values for corresponding pixels in fields a and b are encoded into the video image frame for display. Once corrected, pixel values are entered into the display. The next step is to ascertain whether another pixel is available within the “edge” for processing, as illustrated in step 415. Should there be a pixel available on the “edge,” the process recommences for the available pixel in step 420. Alternatively, should the correction for the “edge” be complete and no pixels remain for processing, the filtering methodology halts recursive statistical computations until another “edge” is selected for processing.

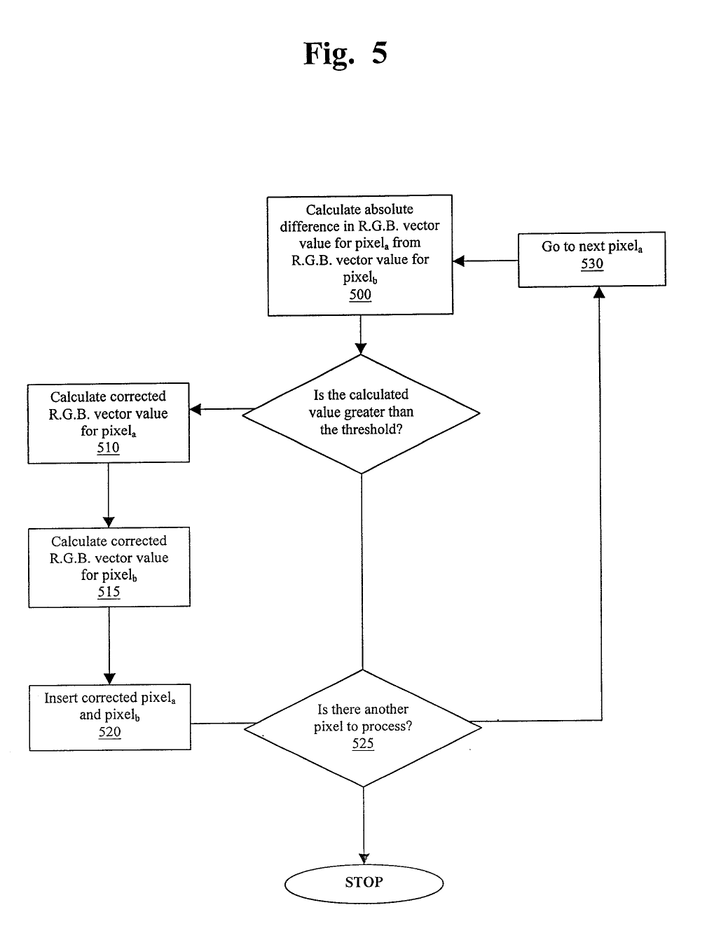

Alternatively, the process for filtering “edge” corrections is illustrated in FIG. 5. A preferable first step 500 includes applying statistical computations to selected pixels to identify any “edge” corrections to be performed. Such statistical computation is performed recursively until every pixel in an “edge” has been assessed and where necessary, corrected.

With reference to FIG. 5, preferable recursive statistical computations to calculate corrected R, G, B vector values for a given pixel ‘n’ in a selected “edge” field a corresponding to “edge” field b include:

(1) the absolute difference of R, G, B vector values in the nth pixel between fields a and b;

(2) the sum of the R, G, B vector values in the nth pixel in field a and double the R, G, B vector values in corresponding nth pixel in field b; and

(3) the multiplication of the calculated sums for each individual R, G, B vector value by one-third.

The generated statistical computation (1) for R, G, B vector values in the nth pixel is preferably applied to an established threshold value in step 505. Should absolute difference amounts in individual R, G, B values fall within the established threshold values based on human perception, no “edge” correction field is generated, as illustrated in step 525, and further pixels in fields a and b are selected for processing. Alternatively, should individual R, G, B difference values fall outside established threshold R, G, B values, corrected R, G, B amounts for given pixels in fields a and b are preferably generated in steps 510 through 520.

Steps 510 through 520 represent ideal statistical application steps for calculating an adjusted pixel to correct “edge” distortion. Step 510 directs calculating corrected individual R, G, B values for a given pixel in field a. Such calculation preferably entails taking the sum of individual R, G, B values for a pixel in field a plus double a corresponding pixel's R, G, B values in field b. Weighted corrected measures of individual R, G, B values are preferably determined by multiplying the calculated sum values for individual R, G, B by one-third (⅓). Such computation captures pixel R, G, B values in field b to be contributed to the correction of given pixel in field a.

Further correction of noise distortion is enabled in step 515. Step 515 directs calculating corrected individual R, G, B values for a given corresponding pixel in field b. Such calculation preferably entails taking the sum of individual R, G, B values for a pixel in field b plus double a corresponding pixel's R, G, B values in field a. Such calculation preferably references an original image frame, as copied in step 300 (FIG. 3), to ensure accurate “edge” correction. The weighted corrected measures of individual R, G, B values for a pixel in field b are preferably determined by multiplying the calculated sum values for individual R, G, B by one-third (⅓). Such computation captures pixel R, G, B values in field a to be contributed to the correction of given pixel in field b.

In step 520, the resulting weighted corrected measures of individual R, G, B values for corresponding pixels in fields a and b are encoded into the video image frame for display. Once corrected pixel values are entered into the display, the next step is to ascertain whether another pixel is available within the “edge” for processing, as illustrated in step 525. Should there be a pixel available on the “edge,” the process recommences for such pixel in step 530. Alternatively, should the correction for the “edge” be complete and no pixels remain for processing, the filtering methodology halts recursive statistical computations until another “edge” is selected for processing.

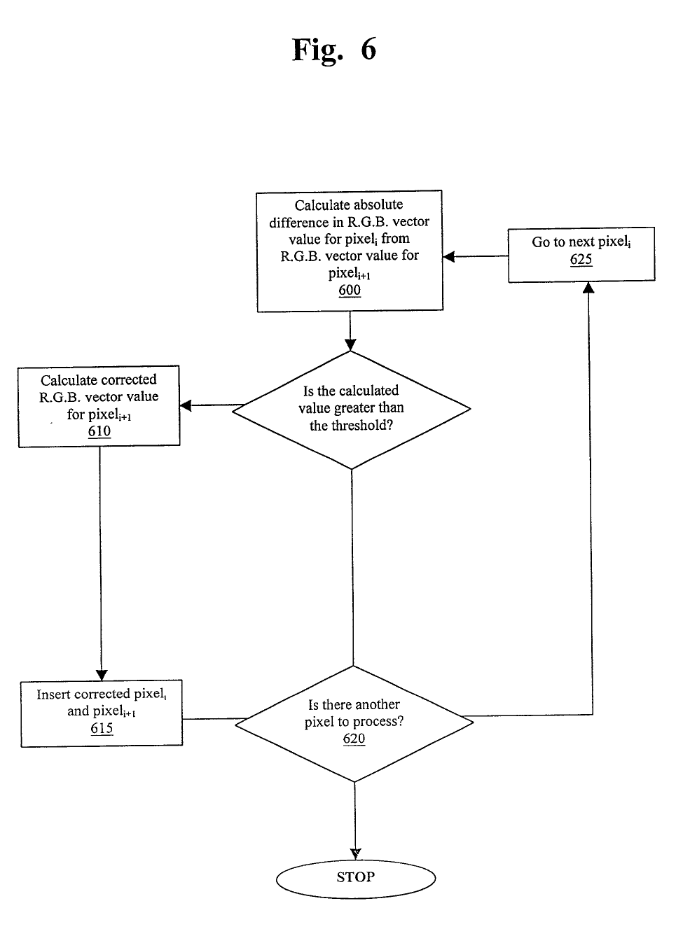

A “temporal” correction step to ensure consistency in resolution between video representation frames is illustrated in FIG. 6. “Edge” pixels, processed either in the previous noise correction filter or edge correction filter, are categorized into frames i and i+1 to denote contiguous frames in an interlaced sequence of video frames. Each nth pixel in a selected “edge” is in frame i or i+1; wherein each nth pixel has delineated R, G, B values to create a plurality of colors. R, G, B values respectively represent red, green, and blue phosphor colors having varying intensities.

With reference to FIG. 6, preferable recursive statistical computation to calculate corrected R, G, B vector values for a given nth pixel in a selected “edge” field in frame i or i+1 include:

(1) the absolute difference of R, G, B values in corresponding nth pixels between frames i and i+1;

(2) the sum of the R, G, B vector values in the nth pixel in frame i and double the R, G., B vector values in the corresponding nth pixel in frame i+1; and

(3) the multiplication of the calculated sums for each individual R, G, B vector value by one-third.

Generated statistical computation (1) for R, G, B values in the nth pixel between frames i and i+1 is preferably applied to established threshold R, G, and B values in step 605. Should absolute difference amounts in individual R, G, B values fall within the established threshold values based on human perception, no “edge” correction field is generated, as illustrated in step 625, and further pixels in frames i and i+1 are selected for processing. Alternatively, should individual R, G, B difference values fall outside established threshold R, G, B values, corrected R, G, B amounts for given pixels in frame i+1 are preferably generated in steps 610 through 620.

Step 610 represents an ideal statistical application step for calculating an adjusted pixel to correct temporal distortion. Step 610 directs calculating corrected individual R,G, B values for a given pixel in frame i+1. Such calculation preferably entails taking the sum of individual R, G, B values for a pixel in frame i+1 plus double a corresponding pixel's R, G, B values in frame i. Weighted corrected measures of individual R, G, B values are preferably determined by multiplying the calculated sum values for individual R, G, B by one-third (⅓). Such computation captures pixel R, G, and B values in frame i to be contributed to the correction of given pixel in frame i+1.

In step 615, the resulting weighted corrected measures of individual R, G, B values for pixels in frames i+1 are encoded into the video image frame i+1 for display. Once corrected pixel values are entered into the display, the next step is to ascertain whether another pixel is available within the “edge” for processing, as illustrated in step 620. Should there be a pixel available on the “edge,” the process recommences for such pixel in step 625. Alternatively, should the correction for the “edge” be complete and no pixels remain for processing, the filtering methodology halts recursive statistical computations until another “edge” is selected for processing.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. A system for filtering decompressed video fields comprising:
means for calculating the following equation
If t>t₀, E_{c}=(aₙ+2*bₙ)/3
wherein t=threshold; t₀=maximum threshold allowed,
wherein aₙ and bₙ are three-dimensional arrays of R, G, and B values for the nth pixel within rows a and b;
wherein E_{c} is a corrected luminance value for a pixel located on a frame edge of a decoded block of video representation comprising a plurality of pixels; and means for storing such corrected luminance value.

2. The system of claim 1, wherein the filtering of decompressed video fields further comprises a means for calculating the following equation
If t>t₀, P_{c}=(a_{f,n}+2*b_{f,n})/3
wherein t=threshold; t₀=maximum threshold allowed
wherein a_{f,n} and b_{f,n} are three-dimensional arrays of R, G, and B values for the nth pixel in said block frame (f) within rows a and b; and
wherein P_{c} is a corrected pixel located within said decoded block frame.

3. The system of claim 1, wherein the calculating means comprises a computer processor.

4. The system of claim 1, further comprising a set top apparatus used in providing multimedia entertainment comprising
a. a networking means for communicating with a network service provider; and
b. a processing means for decoding compressed video fields.

5. A method for filtering decompressed video fields comprising the step of calculating the following equation
If t>t₀, E_{c}=(aₙ+2*bn)/3
wherein t=threshold; t₀=maximum threshold allowed,
wherein aₙ and bₙ are three-dimensional arrays of R, G, and B values for the nth pixel within rows a and b; and
wherein E_{c} is a corrected pixel located on a frame edge of a decoded block of video representation comprising a plurality of pixels.

6. The method of claim 5, further comprising the step of calculating the following equation
If t>t₀, P_{c}=(a_{f,n}+2*b_{f,n})/3
wherein t=threshold; t₀=maximum threshold allowed,
wherein a_{f,n} and b_{f,n} are three-dimensional arrays of R, G, and B values for the nth pixel in said block frame (f) within rows a and b; and
wherein P_{c} is a corrected pixel located within said decoded block frame.

7. The method of claim 5, further comprising a processing means for calculating said equation.

8. The method of claim 7, wherein said processing means comprises a computer.

9. The method of claim 5, further comprising the step of providing multimedia entertainment under MPEG-4 applications using
a. a networking means for communicating with a network service provider; and
b. a processing means for decoding compressed video fields in MPEG-4 application.
